(19) United States
(12) Patent Application Publication
(10) Pub. No.: US 2024/0250795 A1
(43) Pub. Date: Jul. 25, 2024

(54) SEGMENTING DATA FOR TRANSMISSION

(71) Applicant: The Boeing Company, Arlington, VA (US)

(72) Inventor: John D. Williams, Decatur, AL (US)

(21) Appl. No.: 18/158,796

(22) Filed: Jan. 24, 2023

(51) Int. Cl. H04L 5/00; H04W 76/15

(52) U.S. Cl. CPC H04L 5/0053; H04W 76/15

(57) ABSTRACT

A method comprises, at a source computing device, segmenting data into at least a first set of segments and a second set of segments. The first set of segments is encapsulated into a first set of packets. Each of the first set of packets includes a first carrier header formatted in a first predetermined format of a first wireless carrier network. The second set of segments is encapsulated into a second set of packets. Each of the second set of packets includes a second carrier header formatted in a second predetermined format of a second wireless carrier network. The first set of packets is sent to the destination computing device over the first wireless carrier network. The second set of packets is sent to the destination computing device over the second wireless carrier network, to thereby cause the destination computing device to reassemble the data.

### BACKGROUND

For persons working in remote or unfamiliar locations and/or in need of highly secure communications, closed network environments offer communications security advantages over commercial communications networks. Examples of closed network environments include secure satellite networks, secure land-based closed networks, and secure wireless networks. Closed network environments are highly secure because transmitted data remains in the closed network for the entire journey from endpoint to endpoint. However, one disadvantage is that accessibility to such closed network environments can be limited. For example, specialized hardware is required to access satellite networks, and closed land-based networks are only accessible via designated access points, which are offered in a limited number of locations. In contrast, commercial communication networks, such as cellular networks, have several accessibility advantages over such closed network environments. For example, cellular networks can allow users to communicate from any location having suitable reception, using commercially available hardware. Service areas for cellular networks can be more widespread than land-based closed networks, and data transmission rates over cellular networks can be higher than over satellite networks, for example. Cellular networks can also support a higher number of concurrent users. In addition, cellular networks have built-in redundancy that enables communication in case of power outages, natural disasters, and other emergencies. As a result, commercial communication networks such as cellular networks, can be faster, easier to access, and more persistent than closed network environments for many users. A technical challenge exists in improving the security of communications over commercial communications networks, in order to make commercial communications networks a viable option for use in high security situations that currently call for communications over closed network environments.

### SUMMARY

According to one aspect of the present disclosure, a method comprises, at a source computing device, identifying data for transmission to a destination computing device. The data is segmented into at least a first set of segments and a second set of segments collectively including an entirety of the data. The method further comprises encapsulating the first set of segments into a first set of packets. Each of the first set of packets includes a first carrier header formatted in a first predetermined format of a first wireless carrier network associated with a first subscriber identification module (SIM) in the source computing device. The method further comprises encapsulating the second set of segments into a second set of packets. Each of the second set of packets includes a second carrier header formatted in a second predetermined format of a second wireless carrier network associated with a second SIM in the source computing device. The first set of packets is sent to the destination computing device over the first wireless carrier network. The second set of packets is sent to the destination computing device over the second wireless carrier network, to thereby cause the destination computing device to reassemble the data from the first set of packets and the second set of packets.

According to another aspect of the present disclosure, a method comprises, at a destination computing device, receiving a first set of packets over a first wireless carrier network associated with a first SIM in the destination computing device. The first set of packets encapsulates a first set of segments. Each of the first set of packets includes a first carrier header formatted in a first predetermined format of the first wireless carrier network. The method further comprises receiving a second set of packets over a second wireless carrier network associated with a second SIM in the destination computing device. The second set of packets encapsulates a second set of segments. Each of the second set of packets includes a second carrier header formatted in a second predetermined format of the second wireless carrier network. The method further comprises reassembling an entirety of transmitted data from at least the first set of packets and the second set of packets.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example of a source computing device configured to transmit data over a first wireless carrier network and a second wireless carrier network.

FIG. 2 shows an example of a destination computing device configured to receive the data transmitted over the first wireless carrier network and the second wireless carrier network of FIG. 1.

FIG. 3 shows an example embodiment in which the data originates from an application executed on the source computing device of FIG. 1.

FIG. 4 shows another example embodiment in which the source computing device of FIG. 1 receives the data from a user device.

FIG. 5 shows examples of data communication between the source computing device and the user device of FIG. 4.

FIG. 6 shows an example of a first optional intermediate computing device between the first wireless carrier network and the destination computing device of FIG. 2 and a second optional intermediate computing device between the source computing device and the second wireless carrier network of FIG. 1.

FIG. 7 shows an example of transmitting a key to the destination computing device of FIG. 2 over a secure network.

FIG. 8 shows another example of a source computing device configured to encrypt a first set of segments and a second set of segments.

FIG. 9 shows another example of a destination computing device configured to receive and decrypt the first set of segments and the second set of segments of FIG. 8.

FIG. 10 shows another example embodiment in which the destination computing device of FIG. 2 sends the data to another device.

FIG. 11 shows examples of data communication between the destination computing device and the other device of FIG. 10.

FIGS. 12A-12B show a flowchart depicting an example method for segmenting data for transmission at a source computing device.

FIG. 13 shows a flowchart depicting an example method for reassembling transmitted data at a destination computing device.

FIG. 14 schematically shows an example computing system.

### DETAILED DESCRIPTION

As discussed above, commercial communication networks such as cellular networks can have accessibility, resilience, speed, and bandwidth advantages over closed network environments that are compartmentalized from public access, as discussed above. However, such commercial communication networks are generally more vulnerable to message interception as compared to closed network environments. As a result, users requiring highly secure communications, such as military users and first responders, often use closed network environments for their communications, despite the performance drawbacks discussed above. This presents a technical challenge of improving the security of communications over commercial communications networks, in order to make commercial communications networks a viable option for use in high-security situations.

One conventional approach that attempts to solve this technical challenge is encrypting the data sent over commercial communication networks. While encryption can help protect data, it is also vulnerable to interception. An adverse party can gain access and observe messages transmitted over the network over time. This can allow the adverse party to eventually break the encryption.

Another approach to solve this technical challenge is configuring a Subscriber Identity Module (SIM)-enabled device to separate data into two or more messages that are sent at different times from the device over a wireless commercial communication network, such as a 5G network. Sending the data at different times broken into separate messages may make it somewhat more difficult for an adverse party to intercept the separate messages and reassemble the original data. However, this approach does not completely obviate the underlying network vulnerability. An adverse party with continued network access could monitor transmissions and use the SIM identifier to identify messages originating from the same device, and reassemble the messages to read the original data. Thus, this approach exhibits a network security weakness.

To address these issues, examples are disclosed that relate to segmenting data into at least a first set of segments and a second set of segments collectively including an entirety of the data for transmission to a destination computing device. The first set of segments is encapsulated into a first set of packets and the second set of segments is encapsulated into a second set of packets. Each of the first set of packets includes a first carrier header formatted in a first predetermined format of a first wireless carrier network associated with a first SIM in a source computing device. Each of the second set of packets includes a second carrier header formatted in a second predetermined format of a second wireless carrier network associated with a second SIM in the source computing device. This causes, one could say “tricks,” each carrier network to behave as if it is sending a complete message, even though it is not. The first set of packets is sent to the destination computing device over the first wireless carrier network. The second set of packets is sent to the destination computing device over the second wireless carrier network. The destination computing device receives and reassembles the data from the first set of packets and the second set of packets. Segmenting the data in this manner prevents reassembly of the entire message by an unintended recipient. Transmission over two or more different carrier networks increases bandwidth and speed between the source computing device and the destination computing device relative to the use of one carrier network.

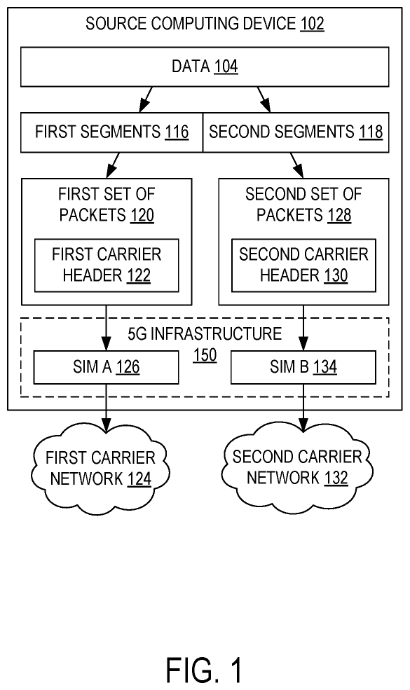

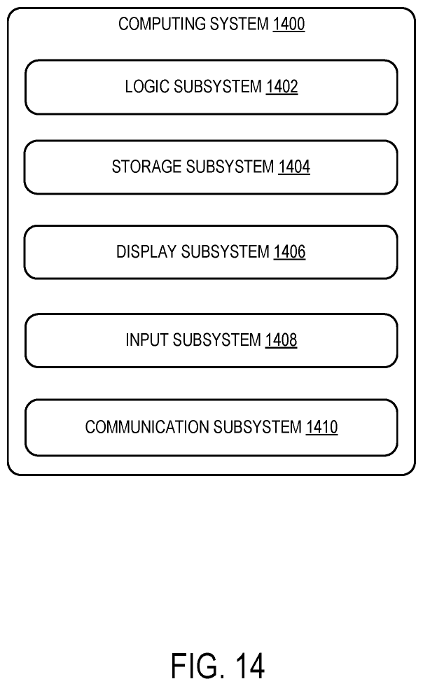

FIG. 1 shows an example of a source computing device 102. The source computing device 102 comprises a processor and a memory storing instructions executable by the processor. The instructions are executable to implement the methods and processes described herein. Additional aspects of the source computing device 102 are described in more detail below with reference to FIG. 14.

As described in more detail below, in some examples, the source computing device 102 comprises a user device. In some such examples, the source computing device 102 comprises a laptop computing device, a tablet computing device, or a mobile computing device (e.g., a smartphone). In this manner, the source computing device 102 can implement the methods and processes described herein at a user level. This can provide greater security and throughput than performing the methods and processes described herein at a remote computing device.

In other examples, the source computing device 102 comprises a server computing device or any other suitable computing device integrated with a communications node. In this manner, at least a portion of the methods and processes disclosed herein are offloaded from the user device.

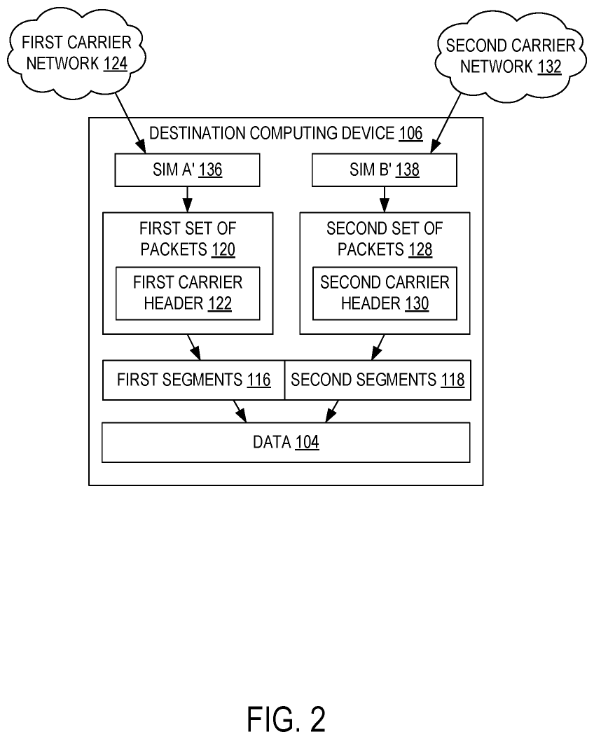

The source computing device 102 is configured to identify data 104 for transmission to a destination computing device. FIG. 2 shows an example of a destination computing device 106. In some examples, the destination computing device 106 comprises a user device. In some such examples, the destination computing device 106 comprises a laptop computing device, a tablet computing device, or a mobile computing device (e.g., a smartphone). In this manner, the destination computing device 106 can implement the methods and processes described herein at a user level. This can provide greater security and throughput than performing the methods and processes described herein at a remote computing device.

In other examples, the destination computing device 106 comprises a server computing device or any other suitable computing device integrated with a communications node. In this manner, at least a portion of the methods and processes disclosed herein are offloaded from the user device.

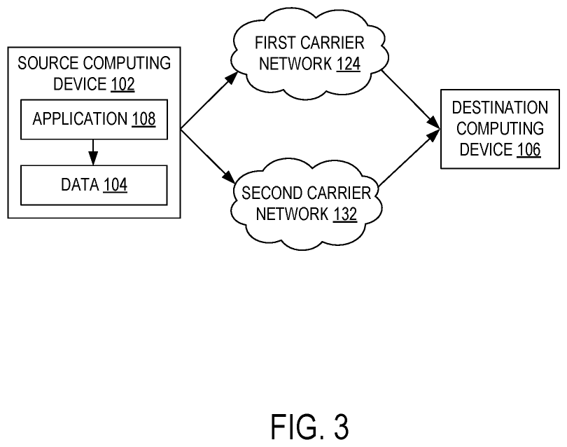

With reference now to FIG. 3, in some examples, identifying the data 104 for transmission to the destination computing device 106 comprises receiving the data 104 from an application 108 executed on the source computing device 102. In some examples, the source computing device 102 comprises a user device, such as a laptop computing device, a tablet computing device, or a smartphone configured to generate the data 104 for transmission to the destination computing device 106. In this manner, the source computing device 102 serves as a user-level core to generate, process, and transmit the data 104 to the destination computing device 106. Implementation at the user level provides greater security and throughput than implementation of the source computing device 102 at a remote communication node that receives the data 104 from another device as a single file or data stream over a secure connection.

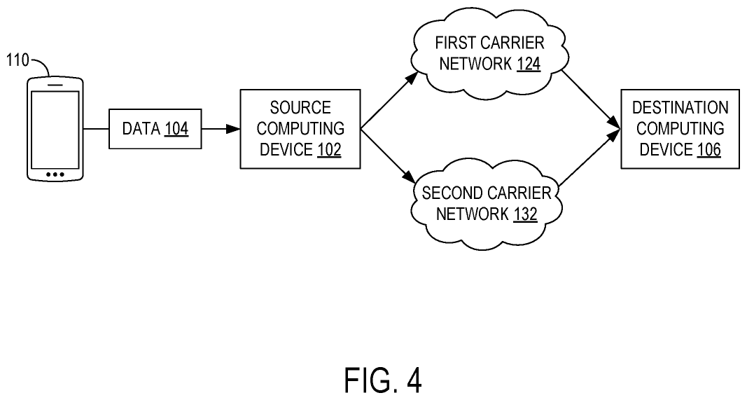

In other examples, and with reference to FIG. 4, identifying the data 104 for transmission comprises receiving the data 104 from a user device 110. In the example of FIG. 4, the user device 110 takes the form of a smartphone. In other examples, the user device comprises any other suitable device type. Other example of suitable device types include a radio, a laptop computing device, and a tablet computing device. In some examples, the source computing device 102 comprises a server computing device or an edge computing device that forms a node in a secure communication network. The source computing device 102 receives the data 104 via a secure connection to the user device 110, and then proceeds to enact at least a portion of the methods and processes herein to transmit the data to the destination computing device 106.

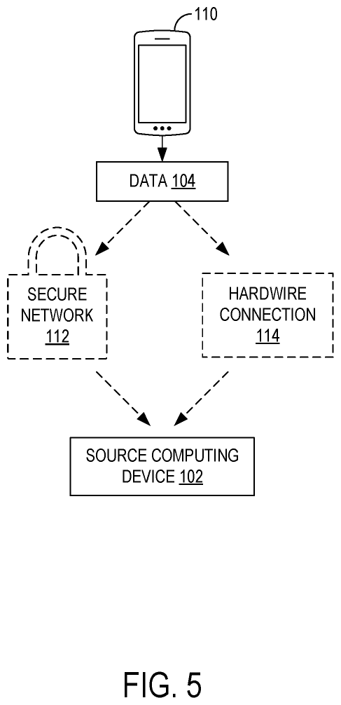

FIG. 5 illustrates an example of the source computing device 102 and the user device 110. In some examples, the source computing device 102 receives the data 104 from the user device 110 over a secure network 112, such as a private Wi-Fi network or a secure satellite link. In other examples, the source computing device 102 receives the data 104 from the user device 110 in any other suitable manner, such as via a hardwire connection 114. In this manner, the data 104 remains secure between the user device 110 and the source computing device 102.

With reference again to FIG. 1, the source computing device 102 is configured to segment the data 104 into at least a first set of segments 116 and a second set of segments 118. In some examples, the first set of segments 116 and the second set of segments 118 collectively include an entirety of the data 104. In other examples, the data 104 is further segmented into any other suitable number of sets of segments. In this manner, the data 104 is separated into discrete segments for separate transmission to the destination computing device 106.

In some examples, the first set of segments 116 comprises one segment and the second set of segments 118 also comprises one segment. In other examples, the first set of segments 116 and/or the second set of segments 118 comprise two or more segments. In this manner, each segment of the first set of segments 116 and the second set of segments 118 has a suitable size for encapsulation in a discrete packet.

As described in more detail below, in some examples, the data 104 is segmented at a separate layer from an application identifying the data 104 for transmission. In some examples, the source computing device 102 segments the data 104 in a discrete application layer underlying a user-facing application layer in a communication protocol stack (e.g., a TCP/IP stack). The discrete application layer automatically processes the data 104 and forwards it down the communication protocol stack for transmission to the destination computing device 106. This enables more rapid data transmission than by manually switching modes of communication. This also ensures that data is packaged appropriately for transmission over different carrier networks and for reassembly by the destination computing device.

In other examples, segmenting the data into at least a first set of segments and a second set of segments comprises using 5G infrastructure 150 on the source computing device 102 to segment the data. In a 5G network implementation, the first wireless carrier network and/or the second wireless carrier network implement multi-channel slicing and framing to enable communication on those respective networks. In some 5G devices, the instructions executed at the source computing device 102 tie in software or firmware utilized by the device for carrier network slicing and framing to segment the data 104 and package the segmented data in the first set of packets and the second set of packets. In this manner, the data is segmented using existing network-compatible infrastructure on the source computing device.

The source computing device 102 is further configured to encapsulate the first set of segments 116 into a first set of packets 120. Each packet of the first set of packets 120 includes a first carrier header 122. The first carrier header 122 is formatted in a first predetermined format of a first wireless carrier network 124 associated with a first SIM (e.g., SIM A 126) in the source computing device 102.

Likewise, the source computing device 102 encapsulates the second set of segments 118 into a second set of packets 128. Each packet of the second set of packets includes a second carrier header 130. The second carrier header 130 is formatted in a second predetermined format of a second wireless carrier network 132 associated with a second SIM (e.g., SIM B 134) in the source computing device 102. It will also be appreciated that the data can be redistributed over any other suitable number of wireless carrier networks (e.g., three or more wireless carrier networks). In other examples, the data can be transmitted over any suitable combination of different modes of communication. For example, the data can be transmitted over one or more wireless carrier networks, one or more Wi-Fi networks, and/or one or more satellite networks.

With reference again to the example of FIG. 1, the encapsulation of the first set of packets 120 and the second set of packets 128 frames each segment of data such that each segment appears as a complete message to a respective wireless carrier network. This allows the source computing device 102 to send separate portions of the data over each wireless carrier network. This prevents interception of the data because only a portion of the data is present on a single wireless carrier network and provides inherent encryption over public networks. In some examples, and as described in more detail below, the first carrier header and the second carrier header also indicate how to reassemble the data at the destination computing device.

As introduced above, the source computing device 102 is configured to send the first set of packets 120 to the destination computing device 106 over the first wireless carrier network 124. The second set of packets 128 is sent to the destination computing device 106 over the second wireless carrier network 132. In some examples, the first wireless carrier network 124 and the second wireless carrier network 132 each comprise a public network. In some such examples, the first wireless carrier network and the second wireless carrier network each comprise a 5G and/or a long-term evolution (LTE) network. Using public networks in this way allows the source computing device and the destination computing device to use existing low-latency communication infrastructure in the local environment.

With reference again to FIG. 2, the destination computing device 106 comprises a third SIM (e.g., SIM A′ 136) for the first wireless carrier network 124 and a fourth SIM (e.g., SIM B′ 138) for the second wireless carrier network 132. The SIM A′ 136 enables the destination computing device 106 to receive the first set of packets 120 over the first wireless carrier network 124. The SIM B′ 138 enables the destination computing device 106 to receive the second set of packets 128 over the second wireless carrier network 132.

In some examples, the destination computing device 106 receives the first set of packets 120 and the second set of packets 128 from a same device. In the examples depicted in FIGS. 3 and 4, the data 104 is transmitted to the destination computing device 106 from the source computing device 102 via the first wireless carrier network 124 and the second wireless carrier network 132.

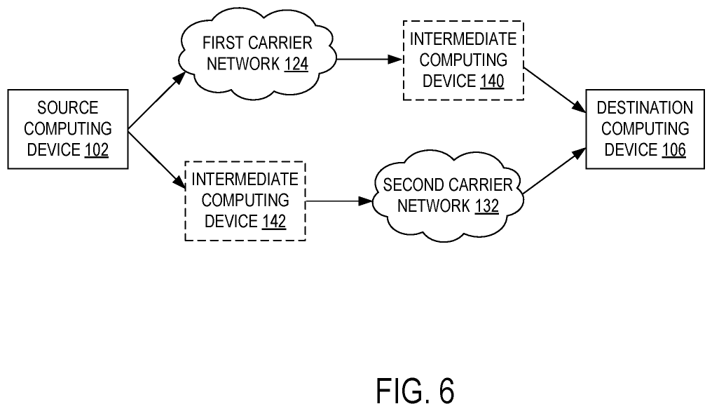

In other examples, the destination computing device 106 receives the first set of packets 120 and the second set of packets 128 from different devices. For example, and with reference now to FIG. 6, a first intermediate computing device 140 is optionally provided between the first wireless carrier network 124 and the destination computing device 106. A second, optional intermediate computing device 142 is additionally or alternatively provided between the source computing device 102 and the second wireless carrier network 132.

With reference again to FIG. 2, the destination computing device 106 is configured to reassemble the entirety of the data 104 from at least the first set of packets 120 and the second set of packets 128. For example, the destination computing device 106 is configured to extract the first set of segments 116 from the first set of packets 120 and the second set of segments 118 from the second set of packets 128. The first set of segments 116 and the second set of segments 118 are then used to reconstruct the data 104.

In some examples, and as introduced above, the source computing device 102 indicates how to reconstruct the data 104 via packet headers. For example, the first carrier header 122 and the second carrier header 130 can each include a sequence variable that indicates a location of each segment in a linear sequence.

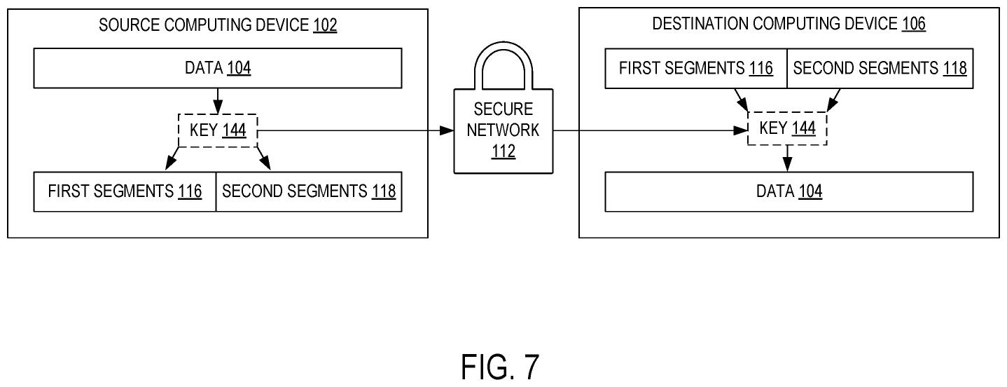

In other examples, and with reference now to FIG. 7, the source computing device 102 generates a key 144. The key 144 maps each segment of the first set of segments 116 and the second set of segments 118 to the data 104. The source computing device 102 transmits the key 144 to the destination computing device 106 over a secure network, such as the secure network 112 of FIG. 5. The key 144 thus enables the destination computing device 106 to reassemble the entirety of the transmitted data 104.

In yet other examples, the destination computing device 106 uses other suitable method to reassemble the data 104. For example, each segment can overlap with another segment. In such examples, the destination computing device 106 recognizes overlapping portions of the segments and uses the overlapping portions to reassemble the data 104.

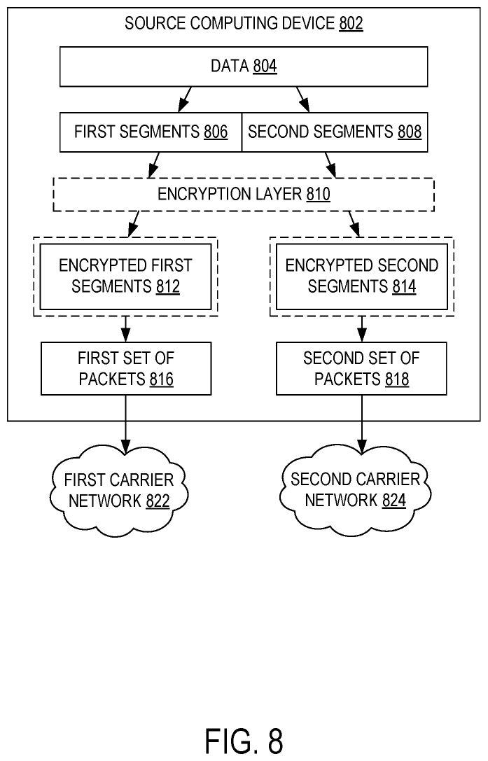

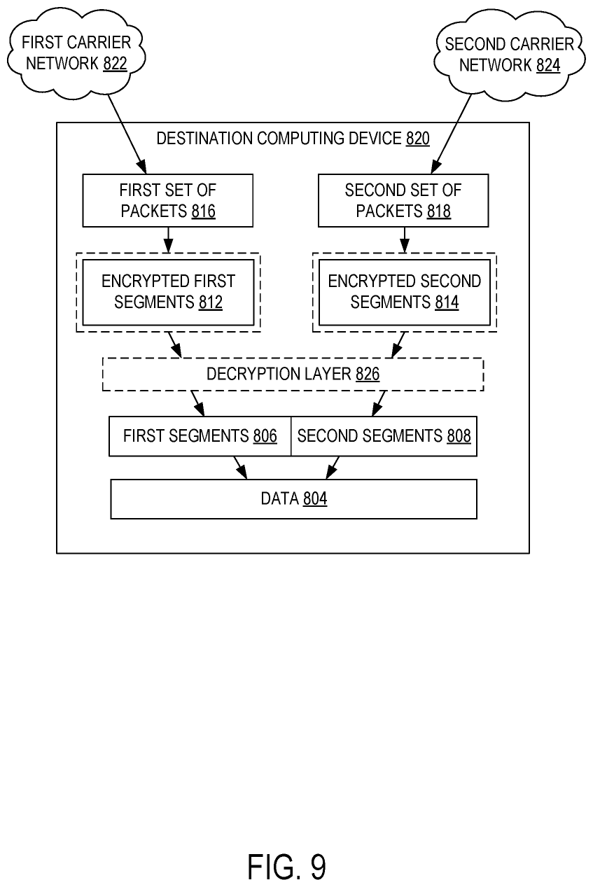

FIGS. 8-9 illustrate another example embodiment in which a first set of segments and a second set of segments are encrypted. FIG. 8 shows an example of a source computing device 802. Like the source computing device 102 of FIG. 1, the source computing device 802 is configured to segment data 804 into a first set of segments 806 and a second set of segments 808. The source computing device 802 optionally includes an encryption layer 810. The encryption layer 810 encrypts the first set of segments 806 and the second set of segments 808 to produce a first encrypted set of segments 812 and a second encrypted set of segments 814, respectively. The first encrypted set of segments 812 and the second encrypted set of segments 814 are packaged in a first set of packets 816 and a second set of packets 818, respectively, as described above. The source computing device 802 transmits the first set of packets 816 and the second set of packets 818 to destination computing device 820 of FIG. 9 via a first wireless carrier network 822 and a second wireless carrier network 824, respectively. The encryption of the first set of segments and the second set of segments provides an additional layer of security during transmission.

The destination computing device 820 receives the first set of packets 816 via the first wireless carrier network 822 and to receive the second set of packets 818 via the second wireless carrier network 824. The destination computing device 820 extracts the first encrypted set of segments 812 and the second encrypted set of segments 814 from the first set of packets 816 and the second set of packets 818, respectively.

The destination computing device 820 further comprises a decryption layer 826. The decryption layer 826 decrypts the first encrypted set of segments 812 and the second encrypted set of segments 814 to reveal the first set of segments 806 and the second set of segments 808. The destination computing device 820 is further configured to reassemble the entirety of the data 804 from the first set of segments 806 and the second set of segments 808 as described above with reference to FIG. 2.

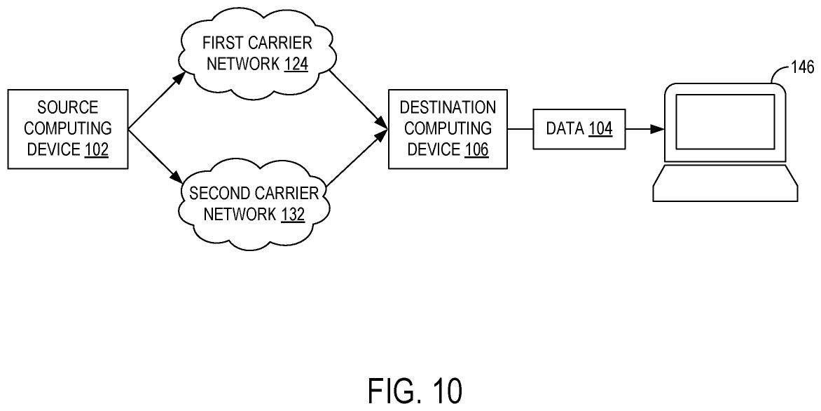

With reference now to FIG. 10, after reassembling the entirety of the data 104, the destination computing device 106 is configured to send the data 104 to another device 146. In the example of FIG. 10, the other device 146 takes the form of a desktop computing device. In other examples, the other device comprises any other suitable device type. Other example of suitable device types include a laptop computing device, a tablet computing device, and a server computing device. In some examples, the destination computing device 106 comprises a server computing device or an edge computing device that forms a node in a secure communication network. The destination computing device 106 reassembles the data 104 as described above, and then proceeds to send the data 104 via a secure connection to the other device 146.

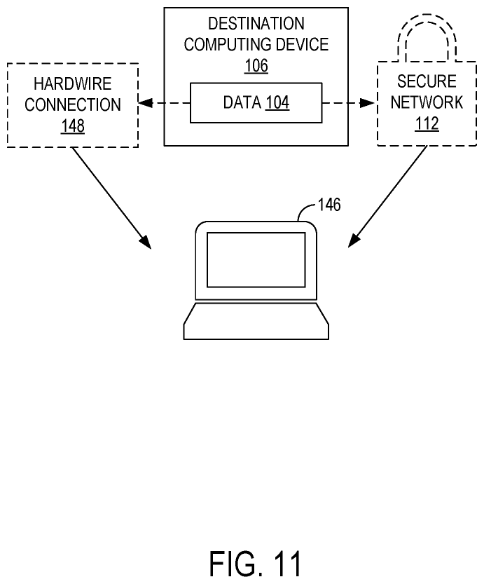

FIG. 11 illustrates an example of the destination computing device 106 and the other device 146. In some examples, the other device 146 receives the data 104 from the destination computing device 106 over a secure network, such as the secure network 112 of FIG. 5. In other examples, the other device 146 receives the data 104 from the destination computing device 106 in any other suitable manner, such as via a hardwire connection 148. In this manner, the data 104 remains secure between the destination computing device 106 and the other device 146.

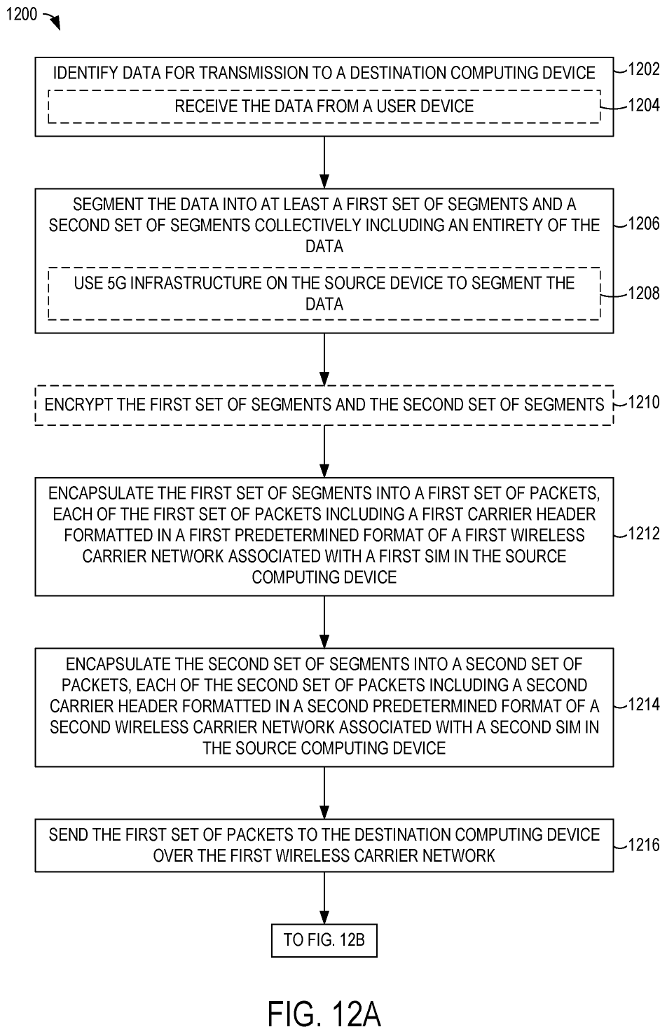

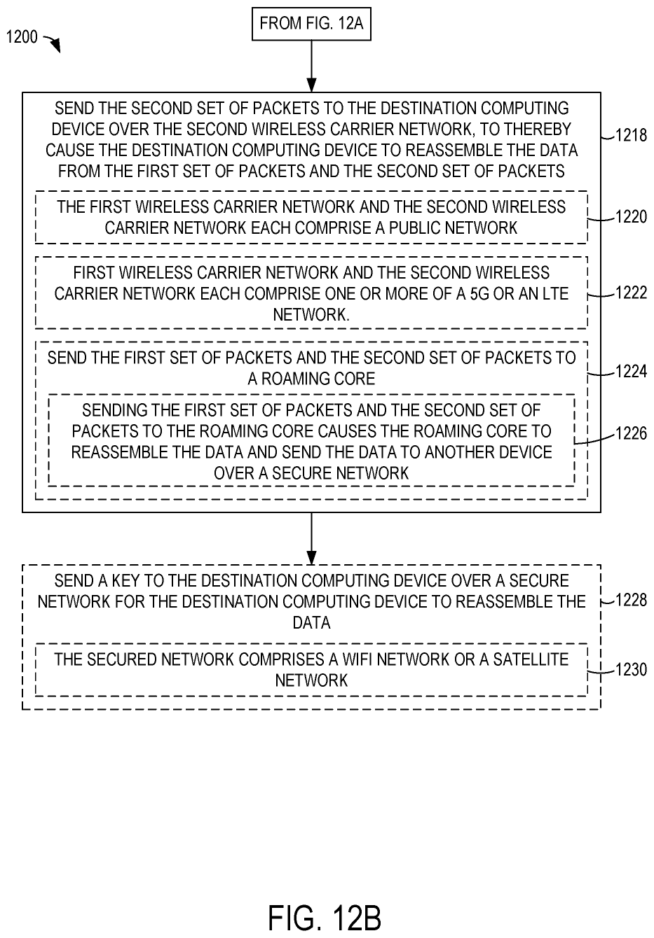

With reference now to FIGS. 12A-12B, a flowchart is illustrated depicting an example method 1200 for segmenting data for transmission at a source computing device. The following description of method 1200 is provided with reference to the components described above and shown in FIGS. 1-11 and 13-14. It will be appreciated that method 1200 also can be performed in other contexts using other suitable hardware and software components.

It will also be appreciated that the following description of method 1200 is provided by way of example and is not meant to be limiting. It will be understood that various steps of method 1200 can be omitted or performed in a different order than described, and that the method 1200 can include additional and/or alternative steps relative to those illustrated in FIGS. 12A-12B without departing from the scope of this disclosure.

With reference first to FIG. 12A, at 1202, the method 1200 comprises identifying data for transmission to a destination computing device. In some examples, at 1204, identifying the data for transmission comprises receiving the data from a user device. For example, the source computing device 102 can receive the data 104 from user device 110 of FIG. 4. In other examples, identifying the data for transmission comprises receiving the data from an application executed on the source computing device. For example, the source computing device 102 can receive the data 104 from the application 108 of FIG. 3. In this manner, the source computing device securely obtains the data for transmission to the destination computing device.

At 1206, the method 1200 comprises segmenting the data into at least a first set of segments and a second set of segments collectively including an entirety of the data. For example, the data 104 of FIG. 1 is segmented into at least the first set of segments 116 and the second set of segments 118. This enables separate transmission of one or more segments to the destination computing device.

In some examples, at 1208, segmenting the data into at least a first set of segments and a second set of segments comprises using 5G infrastructure on the source computing device to segment the data. For example, the 5G infrastructure 150 on the source computing device 102 can be used to segment the data 104. In this manner, existing network-compatible infrastructure can segment the data in a way that appears compatible to the first wireless carrier network 124 and/or the second wireless carrier network 132.

At 1210, in some examples, the method 1200 comprises encrypting the first set of segments and the second set of segments. For example, the first encrypted set of segments 812 is generated by encrypting the first set of segments 806 of FIG. 8. Similarly, the second encrypted set of segments 814 is generated by encrypting the second set of segments 808. This adds another layer of security in addition to the data segmentation.

The method 1200 further comprises, at 1212, encapsulating the first set of segments into a first set of packets, each of the first set of packets including a first carrier header formatted in a first predetermined format of a first wireless carrier network associated with a first SIM in the source computing device. For example, the source computing device 102 encapsulates the first set of segments 116 into the first set of packets 120. Each packet of the first set of packets 120 includes the first carrier header 122 in the first predetermined format of the first wireless carrier network 124 associated with SIM A 126. In this manner, each segment appears as a complete message to the first wireless carrier network.

At 1214, the method 1200 comprises encapsulating the second set of segments into a second set of packets, each of the second set of packets including a second carrier header formatted in a second predetermined format of a second wireless carrier network associated with a second SIM in the source computing device. For example, the source computing device 102 encapsulates the second set of segments 118 into the second set of packets 128. Each packet of the second set of packets includes the second carrier header 130 in the second predetermined format of the second wireless carrier network 132 associated with SIM B 134. Like the first set of packets, the second set of packets frames each segment of data such that each segment appears as a complete message to the second wireless carrier network.

The method 1200 further comprises, at 1216, sending the first set of packets to the destination computing device over the first wireless carrier network. For example, the source computing device 102 of FIG. 1 sends the first set of packets 120 to the destination computing device 106 of FIG. 2 via the first wireless carrier network 124.

Referring now to FIG. 12B, at 1218, the method 1200 comprises sending the second set of packets to the destination computing device over the second wireless carrier network, to thereby cause the destination computing device to reassemble the data from the first set of packets and the second set of packets. For example, the source computing device 102 of FIG. 1 sends the second set of packets 128 to the destination computing device 106 of FIG. 2 via the second wireless carrier network 132. This enables the entirety of the data 104 to pass securely from the source computing device 102 to the destination computing device 106.

In some examples, at 1220, the first wireless carrier network and the second wireless carrier network each comprise a public network. For example, at 1222, the first wireless carrier network and the second wireless carrier network each comprise one or more of a 5G or an LTE network. As described above, this allows the source computing device to leverage existing communication infrastructure.

In some examples, at 1224, sending the first set of packets and the second set of packets to the destination computing device comprises sending the first set of packets and the second set of packets to a roaming core. In the example of FIG. 10, the destination computing device 106 serves as a roaming core. In this manner, the destination computing device 106 functions as an intermediate node within a secure communication network.

At 1226, in some examples, sending the first set of packets and the second set of packets to the roaming core causes the roaming core to reassemble the data and send the data to another device over a secure network. For example, the destination computing device 106 is configured to reassemble and pass along the data 104 to the other device 146. In this manner, the destination computing device 106 provides secure access to the data 104 even in examples where the other device 146 does not directly receive the first set of packets or the second set of packets.

In some examples, the method 1200 comprises, at 1228, sending a key to the destination computing device over a secure network for the destination computing device to reassemble the data. At 1230, in some examples, the secure network comprises a Wi-Fi network or a satellite network.

For example, the source computing device 102 can generate the key 144 as shown in the example of FIG. 7. The source computing device 102 transmits the key 144 to the destination computing device 106. This allows the destination computing device 106 to reassemble the data using the key.

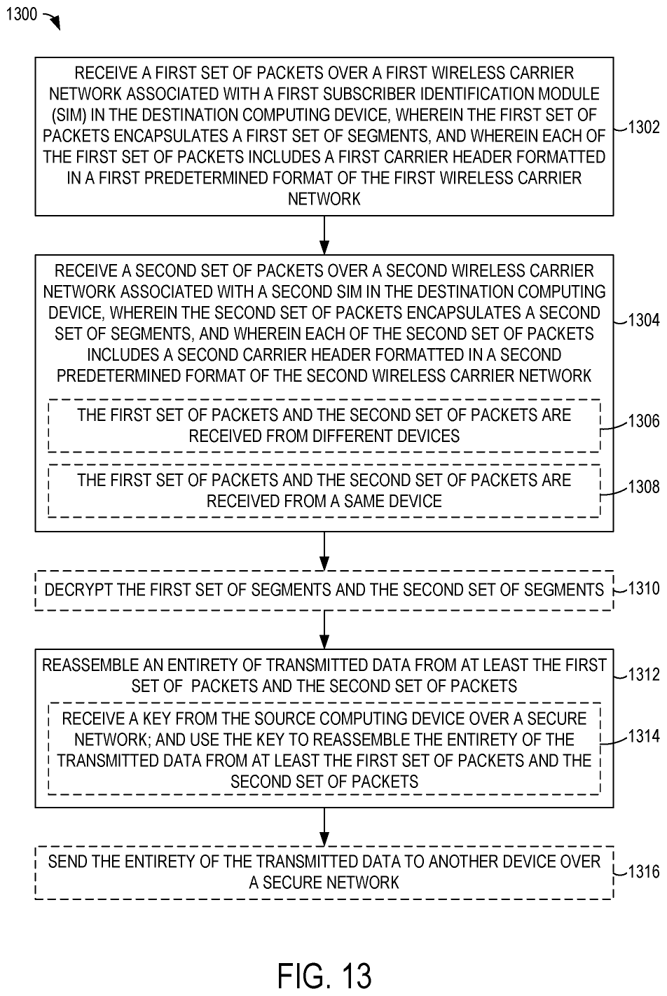

With reference now to FIGS. 13, a flowchart is illustrated depicting an example method 1300 for reassembling transmitted data at a destination computing device. The following description of method 1300 is provided with reference to the components described above and shown in FIGS. 1-12 and 14. It will be appreciated that method 1300 also can be performed in other contexts using other suitable hardware and software components.

It will also be appreciated that the following description of method 1300 is provided by way of example and is not meant to be limiting. It will be understood that various steps of method 1300 can be omitted or performed in a different order than described, and that the method 1300 can include additional and/or alternative steps relative to those illustrated in FIG. 13 without departing from the scope of this disclosure.

At 1302, the method 1300 comprises receiving a first set of packets over a first wireless carrier network associated with a first SIM in the destination computing device, wherein the first set of packets encapsulates a first set of segments, and wherein each of the first set of packets includes a first carrier header formatted in a first predetermined format of the first wireless carrier network. For example, the destination computing device 106 of FIG. 2 receives the first set of packets 120 over the first wireless carrier network 124.

The method 1300 further comprises, at 1304, receiving a second set of packets over a second wireless carrier network associated with a second SIM in the destination computing device, wherein the second set of packets encapsulates a second set of segments, and wherein each of the second set of packets includes a second carrier header formatted in a second predetermined format of the second wireless carrier network. For example, the destination computing device 106 of FIG. 2 receives the second set of packets 128 over the second wireless carrier network 132. As described above, receiving the data 104 in discrete segments provides security and privacy when communicating over public networks.

In some examples, at 1306, the first set of packets and the second set of packets are received from different devices. For example, the destination computing device 106 can receive the first set of packets from the intermediate computing device 140 of FIG. 1 and receive the second set of packets from the second wireless carrier network 132 (e.g., via SIM B′ 138). In this manner, data reception can be distributed among two or more different devices.

At 1308, in some examples, the first set of packets and the second set of packets are received from a same device. For example, the destination computing device 106 can receive the first set of packets 120 and the second set of packets 128 from the destination computing device 106 via the first wireless carrier network 124 and the second wireless carrier network 132. In this manner, the data is received at the source computing device without an additional connection to an intermediate computing device.

In some examples, at 1310, the method 1300 comprises decrypting the first set of segments and the second set of segments. For example, the destination computing device 820 of FIG. 9 is configured to decrypt the first encrypted set of segments 812 and the second encrypted set of segments 814. As described above, this layer of encryption provides additional security.

At 1312, the method 1300 comprises reassembling an entirety of transmitted data from at least the first set of packets and the second set of packets. For example, the destination computing device 106 of FIG. 2 reassembles the data 104 from the first set of segments 116 and the second set of segments 118. This enables the destination computing device to securely obtain the entirety of the data 104.

In some examples, at 1314, the method 1300 comprises receiving a key from the source computing device over a secure network and using the key to reassemble the entirety of the transmitted data from at least the first set of packets and the second set of packets. For example, the destination computing device 106 can use the key 144 of FIG. 7 to reassemble the data. Use of the key simplifies assembly of the data.

At 1316, in some examples, the method 1300 comprises, after reassembling the entirety of the transmitted data, sending the entirety of the transmitted data to another device over a secure network. For example, in FIG. 10, the destination computing device 106 serves as a roaming core. In this manner, the destination computing device 106 is configured to reassemble and pass along the data 104 to the other device 146.

As described above, the methods and devices disclosed herein enable data to be securely transmitted over wireless carrier networks. The data is segmented into at least a first set of segments and a second set of segments collectively including an entirety of the data. Segmentation protects the data from being intercepted and reassembled by any unintended recipient. Each of the segments is packaged into a packet formatted for a respective wireless carrier network. Each packet appears as a complete message to the respective wireless carrier network. One or more of the segments are transmitted over a different wireless carrier network than the remainder of the segments. Transmission over two or more different carrier networks increases bandwidth and speed between the source computing device and the destination computing device relative to the use of one carrier network.

In some embodiments, the methods and processes described herein may be tied to a computing system of one or more computing devices. In particular, such methods and processes may be implemented in hardware as described above, as a computer-application program or service, an application-programming interface (API), a library, and/or other computer-program product.

FIG. 14 schematically shows a simplified representation of a computing system 1400 configured to provide any to all of the compute functionality described herein. Computing system 1400 may take the form of one or more personal computers, server computers, and mobile communication devices (e.g., a smartphone), as examples. Source computing device 102 and destination computing device 106 are examples of computing system 1400.

Computing system 1400 includes a logic subsystem 1402 and a storage subsystem 1404. Computing system 1400 may optionally include a display subsystem 1406, input subsystem 1408, communication subsystem 1410, and/or other subsystems not shown in FIG. 14.

Logic subsystem 1402 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely accessible, networked computing devices configured in a cloud-computing configuration.

Storage subsystem 1404 includes one or more physical devices configured to temporarily and/or permanently hold computer information such as data and instructions executable by the logic subsystem. When the storage subsystem includes two or more devices, the devices may be collocated and/or remotely located. Storage subsystem 1404 may include volatile, nonvolatile, dynamic, static, read/write, read-only, random-access, sequential-access, location-addressable, file-addressable, and/or content-addressable devices. Storage subsystem 1404 may include removable and/or built-in devices. When the logic subsystem executes instructions, the state of storage subsystem 1404 may be transformed—e.g., to hold different data.

Storage subsystem 1404 may include removable and/or built-in devices. Storage subsystem 1404 may include optical memory (e.g., CD, DVD, HD-DVD, Blu-Ray Disc, etc.), semiconductor memory (e.g., RAM, EPROM, EEPROM, etc.), and/or magnetic memory, among others. Storage subsystem 1404 may include volatile, nonvolatile, dynamic, static, read/write, read-only, random-access, sequential-access, location-addressable, file-addressable, and/or content-addressable devices.

Aspects of logic subsystem 1402 and storage subsystem 1404 may be integrated together into one or more hardware-logic components. Such hardware-logic components may include program- and application-specific integrated circuits (PASIC /ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

When included, display subsystem 1406 may be used to present a visual representation of data held by storage subsystem 1404. This visual representation may take the form of a graphical user interface (GUI). As the herein described methods and processes change the data held by the storage subsystem, and thus transform the state of the storage subsystem, the state of display subsystem 1406 may likewise be transformed to visually represent changes in the underlying data. Display subsystem 1406 may include one or more display devices utilizing virtually any type of technology. Such display devices may be combined with the logic subsystem and the storage subsystem in a shared enclosure, or such display devices may be peripheral display devices.

When included, input subsystem 1408 may comprise or interface with one or more input devices such as a keyboard and touch screen. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; and an infrared, color, stereoscopic, and/or depth camera for machine vision and/or gesture recognition.

When included, communication subsystem 1410 may be configured to communicatively couple computing system 1400 with one or more other computing devices. Communication subsystem 1410 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1400 to send and/or receive messages to and/or from other devices via a network such as the Internet.

Further, the disclosure comprises configurations according to the following clauses.

Clause 1. At a source computing device, a method comprising: identifying data for transmission to a destination computing device; segmenting the data into at least a first set of segments and a second set of segments collectively including an entirety of the data; encapsulating the first set of segments into a first set of packets, each of the first set of packets including a first carrier header formatted in a first predetermined format of a first wireless carrier network associated with a first subscriber identification module (SIM) in the source computing device; encapsulating the second set of segments into a second set of packets, each of the second set of packets including a second carrier header formatted in a second predetermined format of a second wireless carrier network associated with a second SIM in the source computing device; sending the first set of packets to the destination computing device over the first wireless carrier network; and sending the second set of packets to the destination computing device over the second wireless carrier network, to thereby cause the destination computing device to reassemble the data from the first set of packets and the second set of packets.

Clause 2. The method of clause 1, further comprising sending a key to the destination computing device over a secure network for the destination computing device to reassemble the data.

Clause 3. The method of clause 2, wherein the secure network comprises a Wi-Fi network or a satellite network.

Clause 4. The method of clause 1, wherein identifying the data for transmission comprises receiving the data from a user device.

Clause 5. The method of clause 1, wherein sending the first set of packets and the second set of packets to the destination computing device comprises sending the first set of packets and the second set of packets to a roaming core.

Clause 6. The method of clause 5, wherein sending the first set of packets and the second set of packets to the roaming core causes the roaming core to reassemble the data and send the data to another device over a secure network.

Clause 7. The method of clause 1, wherein the first wireless carrier network and the second wireless carrier network each comprise a public network.

Clause 8. The method of clause 1, wherein the first wireless carrier network and the second wireless carrier network each comprise one or more of a 5G or a long-term evolution (LTE) network.

Clause 9. The method of clause 1, further comprising encrypting the first set of segments and the second set of segments.

Clause 10. The method of clause 1, wherein segmenting the data into at least a first set of segments and a second set of segments comprises using 5G infrastructure on the source computing device to segment the data.

Clause 11. At a destination computing device, a method comprising: receiving a first set of packets over a first wireless carrier network associated with a first subscriber identification module (SIM) in the destination computing device, wherein the first set of packets encapsulates a first set of segments, and wherein each of the first set of packets includes a first carrier header formatted in a first predetermined format of the first wireless carrier network; receiving a second set of packets over a second wireless carrier network associated with a second SIM in the destination computing device, wherein the second set of packets encapsulates a second set of segments, and wherein each of the second set of packets includes a second carrier header formatted in a second predetermined format of the second wireless carrier network; and reassembling an entirety of transmitted data from at least the first set of packets and the second set of packets.

Clause 12. The method of clause 11, further comprising: receiving a key from a source computing device over a secure network; and using the key to reassemble the entirety of the transmitted data from at least the first set of packets and the second set of packets.

Clause 13. The method of clause 11, wherein the first set of packets and the second set of packets are received from different devices.

Clause 14. The method of clause 11, wherein the first set of packets and the second set of packets are received from a same device.

Clause 15. The method of clause 11, further comprising, after reassembling the entirety of the transmitted data, sending the entirety of the transmitted data to another device over a secure network.

Clause 16. The method of clause 11, further comprising decrypting the first set of segments and the second set of segments.

Clause 17. A computing system, comprising: a first subscriber identification module (SIM) for a first wireless carrier network; a second SIM for a second wireless carrier network; and one or more processors configured to identify data for transmission to a destination computing device; segment the data into at least a first set of segments and a second set of segments collectively including an entirety of the data; encapsulate the first set of segments into a first set of packets, each of the first set of packets including a first carrier header formatted in a first predetermined format of the first wireless carrier network; encapsulate the second set of segments into a second set of packets, each of the second set of packets including a second carrier header formatted in a second predetermined format of the second wireless carrier network; send the first set of packets to the destination computing device over the first wireless carrier network; and send the second set of packets to the destination computing device over the second wireless carrier network, to thereby cause the destination computing device to reassemble the data from the first set of packets and the second set of packets.

Clause 18. The computing system of clause 17, wherein the one or more processors are further configured to send a key to the destination computing device over a secure network for the destination computing device to reassemble the data.

Clause 19. The computing system of clause 17, wherein the destination computing device comprises a roaming core.

Clause 20. The computing system of clause 17, wherein the one or more processors are further configured to encrypt the first set of segments and the second set of segments.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

“And/or” as used herein is defined as the inclusive or V, as specified by the following truth table:

| A | B | A∨B |
|---|---|---|
| True | True | True |
| True | False | True |
| False | True | True |
| False | False | False |

The terminology “one or more of A or B” as used herein comprises A, B, or a combination of A and B. The terminology “one or more of A, B, or C” is equivalent to A, B, and/or C. As such, “one or more of A, B, or C” as used herein comprises A individually, B individually, C individually, a combination of A and B, a combination of A and C, a combination of B and C, or a combination of A, B and C.

It will be understood that the configurations and/or approaches described herein are exemplary in nature, and that these specific embodiments or examples are not to be considered in a limiting sense, because numerous variations are possible. The specific routines or methods described herein may represent one or more of any number of strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. At a source computing device, a method comprising:
identifying data for transmission to a destination computing device;
segmenting the data into at least a first set of segments and a second set of segments collectively including an entirety of the data;
encapsulating the first set of segments into a first set of packets, each of the first set of packets including a first carrier header formatted in a first predetermined format of a first wireless carrier network associated with a first subscriber identification module (SIM) in the source computing device;
encapsulating the second set of segments into a second set of packets, each of the second set of packets including a second carrier header formatted in a second predetermined format of a second wireless carrier network associated with a second SIM in the source computing device;
sending the first set of packets to the destination computing device over the first wireless carrier network; and
sending the second set of packets to the destination computing device over the second wireless carrier network, to thereby cause the destination computing device to reassemble the data from the first set of packets and the second set of packets.

2. The method of claim 1, further comprising sending a key to the destination computing device over a secure network for the destination computing device to reassemble the data.

3. The method of claim 2, wherein the secure network comprises a Wi-Fi network or a satellite network.

4. The method of claim 1, wherein identifying the data for transmission comprises receiving the data from a user device.

5. The method of claim 1, wherein sending the first set of packets and the second set of packets to the destination computing device comprises sending the first set of packets and the second set of packets to a roaming core.

6. The method of claim 5, wherein sending the first set of packets and the second set of packets to the roaming core causes the roaming core to reassemble the data and send the data to another device over a secure network.

7. The method of claim 1, wherein the first wireless carrier network and the second wireless carrier network each comprise a public network.

8. The method of claim 1, wherein the first wireless carrier network and the second wireless carrier network each comprise one or more of a 5G or a long-term evolution (LTE) network.

9. The method of claim 1, further comprising encrypting the first set of segments and the second set of segments.

10. The method of claim 1, wherein segmenting the data into at least a first set of segments and a second set of segments comprises using 5G infrastructure on the source computing device to segment the data.

11. At a destination computing device, a method comprising:
receiving a first set of packets over a first wireless carrier network associated with a first subscriber identification module (SIM) in the destination computing device,
wherein the first set of packets encapsulates a first set of segments, and
wherein each of the first set of packets includes a first carrier header formatted in a first predetermined format of the first wireless carrier network;
receiving a second set of packets over a second wireless carrier network associated with a second SIM in the destination computing device,
wherein the second set of packets encapsulates a second set of segments, and
wherein each of the second set of packets includes a second carrier header formatted in a second predetermined format of the second wireless carrier network; and
reassembling an entirety of transmitted data from at least the first set of packets and the second set of packets.

12. The method of claim 11, further comprising:
receiving a key from a source computing device over a secure network; and
using the key to reassemble the entirety of the transmitted data from at least the first set of packets and the second set of packets.

13. The method of claim 11, wherein the first set of packets and the second set of packets are received from different devices.

14. The method of claim 11, wherein the first set of packets and the second set of packets are received from a same device.

15. The method of claim 11, further comprising, after reassembling the entirety of the transmitted data, sending the entirety of the transmitted data to another device over a secure network.

16. The method of claim 11, further comprising decrypting the first set of segments and the second set of segments.

17. A computing system, comprising:
a first subscriber identification module (SIM) for a first wireless carrier network;
a second SIM for a second wireless carrier network; and
one or more processors configured to
identify data for transmission to a destination computing device;
segment the data into at least a first set of segments and a second set of segments collectively including an entirety of the data;
encapsulate the first set of segments into a first set of packets, each of the first set of packets including a first carrier header formatted in a first predetermined format of the first wireless carrier network;
encapsulate the second set of segments into a second set of packets, each of the second set of packets including a second carrier header formatted in a second predetermined format of the second wireless carrier network;
send the first set of packets to the destination computing device over the first wireless carrier network; and
send the second set of packets to the destination computing device over the second wireless carrier network, to thereby cause the destination computing device to reassemble the data from the first set of packets and the second set of packets.

18. The computing system of claim 17, wherein the one or more processors are further configured to send a key to the destination computing device over a secure network for the destination computing device to reassemble the data.

19. The computing system of claim 17, wherein the destination computing device comprises a roaming core.

20. The computing system of claim 17, wherein the one or more processors are further configured to encrypt the first set of segments and the second set of segments.
